(19) United States
(12) Patent Application Publication
(10) Pub. No.: US 2018/0274370 A1
(43) Pub. Date: Sep. 27, 2018

(54) ENGINE COMPONENT FOR A GAS TURBINE ENGINE

(71) Applicant: GENERAL ELECTRIC COMPANY, Schenectady, NY (US)

(72) Inventors: Ronald Scott BUNKER, West Chester, OH (US); Timothy Deryck STONE, Cincinnati, OH (US)

(21) Appl. No.: 15/522,830

(22) PCT Filed: Oct. 28, 2015
(86) PCT No.: PCT/US15/57718

§ 371 Date: Apr. 28, 2017

Related U.S. Application Data
(60) Provisional application No. 62/073,429, filed on Oct. 31, 2014.
(60) Provisional application No. 62/073,455, filed on Oct. 31, 2014.

(51) Int. Cl. F01D 5/18; F23R 3/00; F23R 3/06

(52) U.S. Cl. CPC F01D 5/186; F23R 3/002; F23R 3/06; F05D 2250/181; F23R 2900/03042; F05D 2250/24; F05D 2250/292; F05D 2250/51; F05D 2260/202; F05D 2250/184

(57) ABSTRACT

An engine component for a gas turbine engine includes a film-cooled wall having a hot surface facing hot combustion gas and a cooling surface facing a cooling fluid flow. The wall includes one or more film holes that have an outlet provided on the hot surface and a contoured inlet provided on the cooling surface. A contoured portion in the cooling surface encompasses the inlets for two or more film holes in the wall.

### BACKGROUND OF THE INVENTION

Turbine engines, and particularly gas or combustion turbine engines, are rotary engines that extract energy from a flow of combusted gases passing through the engine onto a multitude of turbine blades. Gas turbine engines have been used for land and nautical locomotion and power generation, but are most commonly used for aeronautical applications such as for aircraft, including helicopters. In aircraft, gas turbine engines are used for propulsion of the aircraft. In terrestrial applications, turbine engines are often used for power generation.

Gas turbine engines for aircraft are designed to operate at high temperatures to maximize engine efficiency, so cooling of certain engine components, such as the high pressure turbine and the low pressure turbine, may be necessary. Typically, cooling is accomplished by ducting cooler air from the high and/or low pressure compressors to the engine components which require cooling. Temperatures in the high pressure turbine are around 1000° C. to 2000° C. and the cooling air from the compressor is around 500° C. to 700° C. While the compressor air is a high temperature, it is cooler relative to the turbine air, and may be used to cool the turbine.

Particles, such as dirt, dust, sand, and other environmental contaminants, in the cooling air can cause a loss of cooling and reduced operational time or “time-on-wing” for the aircraft environment. For example, particles supplied to the turbine components can clog, obstruct, or coat the flow passages and surfaces of the components, which can reduce the lifespan of the turbine. In particular, particles can coat and block the film holes present in components. This problem is exacerbated in certain operating environments around the globe where turbine engines are exposed to significant amounts of airborne particles.

### BRIEF DESCRIPTION

In one aspect, the technology described herein relates to an engine component for a gas turbine engine generating hot combustion gas, the engine component having a wall at least partially defining an interior cavity and separating the hot combustion gas from a cooling fluid flow supplied to the interior cavity and having a hot surface facing the hot combustion gas and a cooling surface facing the cooling fluid flow, and a film hole having an inlet provided on the cooling surface, an outlet provided on the hot surface, and a passage connecting the inlet and the outlet, with the passage defining a metering section, wherein the inlet comprises a flared portion flaring inwardly from the cooling surface and about the entire circumference of the inlet.

In another aspect, the technology described herein relates to an engine component for a gas turbine engine generating hot combustion gas, the engine component having a wall at least partially defining an interior cavity and separating the hot combustion gas from a cooling fluid flow supplied to the interior cavity and having a hot surface facing the hot combustion gas and a cooling surface facing the cooling fluid flow, and a film hole having an inlet provided on the cooling surface, an outlet provided on the hot surface, and a passage connecting the inlet and the outlet, with the passage defining a metering section, wherein the inlet comprises at least one flute extending inwardly from the cooling surface to the passage.

In yet another aspect, the technology described herein relates to an engine component for a gas turbine engine generating hot combustion gas. The engine component includes a wall separating the hot combustion gas from a cooling fluid flow and having a hot surface facing the hot combustion gas and a cooling surface facing the cooling fluid flow, multiple film holes having an inlet provided on the cooling surface, an outlet provided on the hot surface, and a passage connecting the inlet and the outlet, with the passage defining a metering section, and a contoured portion provided in the cooling surface and encompassing the inlets for at least two of the film holes.

### BRIEF DESCRIPTION OF THE DRAWINGS

In the drawings:

FIG. 1 is a schematic cross-sectional diagram of a gas turbine engine for an aircraft.

FIG. 2 is a side section view of a combustor and high pressure turbine of the engine from FIG. 1.

FIG. 3 is a schematic view showing a portion of an engine component of the engine from FIG. 1 according to a first embodiment of the invention.

FIG. 4 is a sectional view through a film hole of the engine component from FIG. 3.

FIG. 5 is a plan view of a cooling surface of the engine component from FIG. 3.

FIG. 6 is a plan view of an inlet for a film hole of the engine component from FIG. 3.

FIG. 7 is a sectional view of an engine component having a film-cooled wall in accordance with a second embodiment of the invention.

FIG. 8 is a plan view of a cooling surface of the engine component from FIG. 7.

FIG. 9 is a sectional view of an engine component having a film-cooled wall in accordance with a third embodiment of the invention.

FIG. 10 is a plan view of a cooling surface of the engine component from FIG. 9.

FIG. 11 is a sectional view of an engine component having a film-cooled wall in accordance with a fourth embodiment of the invention.

FIG. 12 is a plan view of a cooling surface of the engine component from FIG. 11.

FIG. 13 is a perspective view of a portion of an engine component having a film-cooled wall in accordance with a fifth embodiment of the invention.

FIG. 14 is a perspective view of a portion of an engine component having a film-cooled wall in accordance with a sixth embodiment of the invention.

FIG. 15 is a perspective view of a portion of an engine component having a film-cooled wall in accordance with a seventh embodiment of the invention.

FIG. 16 is a perspective view of a portion of an engine component having a film-cooled wall in accordance with an eighth embodiment of the invention.

FIG. 17 is a perspective view of a portion of an engine component having a film-cooled wall in accordance with a ninth embodiment of the invention.

FIG. 18 is a perspective view of a portion of an engine component having a film-cooled wall in accordance with a tenth embodiment of the invention.

FIG. 19 is a perspective view of a portion of an engine component having a film-cooled wall in accordance with an eleventh embodiment of the invention.

FIG. 20 is a perspective view of a portion of an engine component having a film-cooled wall in accordance with a twelfth embodiment of the invention.

FIG. 21 is a perspective view of a portion of an engine component having a film-cooled wall in accordance with a thirteenth embodiment of the invention.

FIG. 22 is a perspective view of a portion of an engine component having a film-cooled wall in accordance with a fourteenth embodiment of the invention.

FIG. 23 is a perspective view of a portion of an engine component having a film-cooled wall in accordance with a fifteenth embodiment of the invention.

FIG. 24 is a perspective view of a portion of an engine component having a film-cooled wall in accordance with a sixteenth embodiment of the invention.

FIG. 25 is a perspective view of a portion of an engine component having a film-cooled wall in accordance with a seventeenth embodiment of the invention.

### DETAILED DESCRIPTION

The described embodiments of the technology described herein are directed to a film-cooled engine component, particularly in a gas turbine engine. For purposes of illustration, the technology described herein will be described with respect to an aircraft gas turbine engine. It will be understood, however, that the technology described herein is not so limited and may have general applicability in non-aircraft applications, such as other mobile applications and non-mobile industrial, commercial, and residential applications.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to a direction toward the rear or outlet of the engine relative to the engine centerline.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

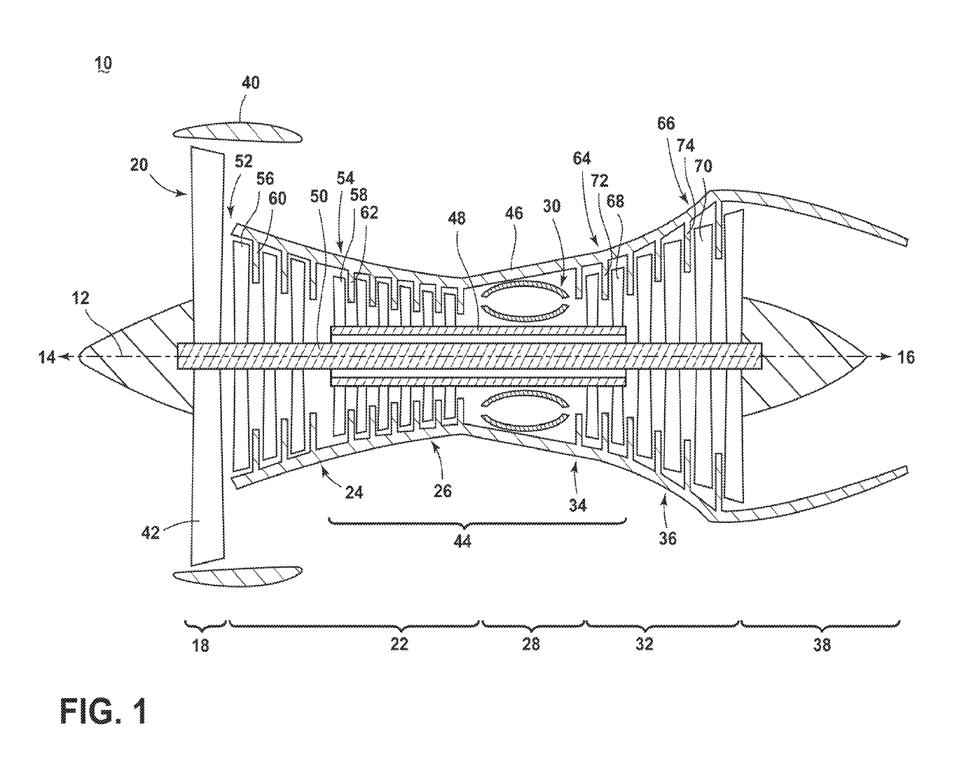

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12.

The HP compressor 26, the combustor 30, and the HP turbine 34 form a core 44 of the engine 10 which generates combustion gases. The core 44 is surrounded by core casing 46 which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 may be provided in a ring and may extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 may be provided in a ring and may extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the ambient air supplied by the fan 20 may bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid may be, but is not limited to, fluid discharged from the LP compressor 24 or the HP compressor 26.

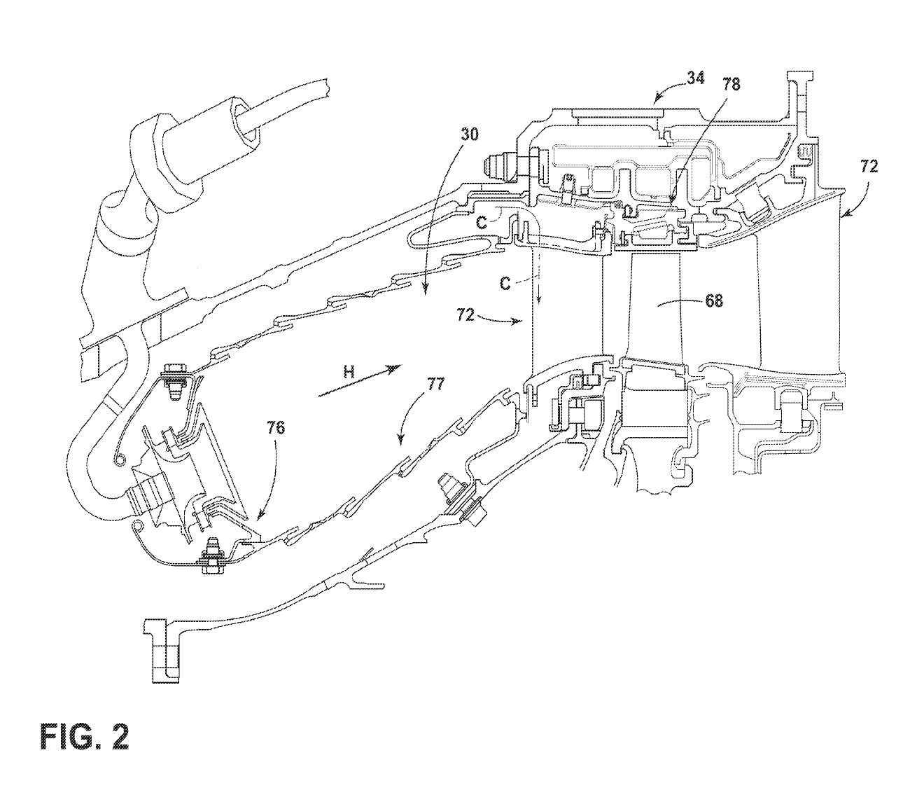

FIG. 2 is a side section view of the combustor 30 and HP turbine 34 of the engine 10 from FIG. 1. The combustor 30 includes a deflector 76 and a combustor liner 77. Adjacent to the turbine blade 68 of the turbine 34 in the axial direction are sets of static turbine vanes 72, with adjacent vanes 72 forming nozzles therebetween. The nozzles turn combustion gas so that the maximum energy may be extracted by the turbine 34. A cooling fluid flow C passes through the vanes 72 to cool the vanes 72 as hot combustion gas H passes along the exterior of the vanes 72. A shroud assembly 78 is adjacent to the rotating blade 68 to minimize flow loss in the turbine 34. Similar shroud assemblies can also be associated with the LP turbine 36, the LP compressor 24, or the HP compressor 26.

One or more of the engine components of the engine 10 has a film-cooled wall in which various film hole embodiments disclosed further herein may be utilized. Some non-limiting examples of the engine component having a film-cooled wall can include the blades 68, 70, vanes or nozzles 72, 74, combustor deflector 76, combustor liner 77, or shroud assembly 78, described in FIGS. 1-2. Other non-limiting examples where film cooling is used include turbine transition ducts and exhaust nozzles.

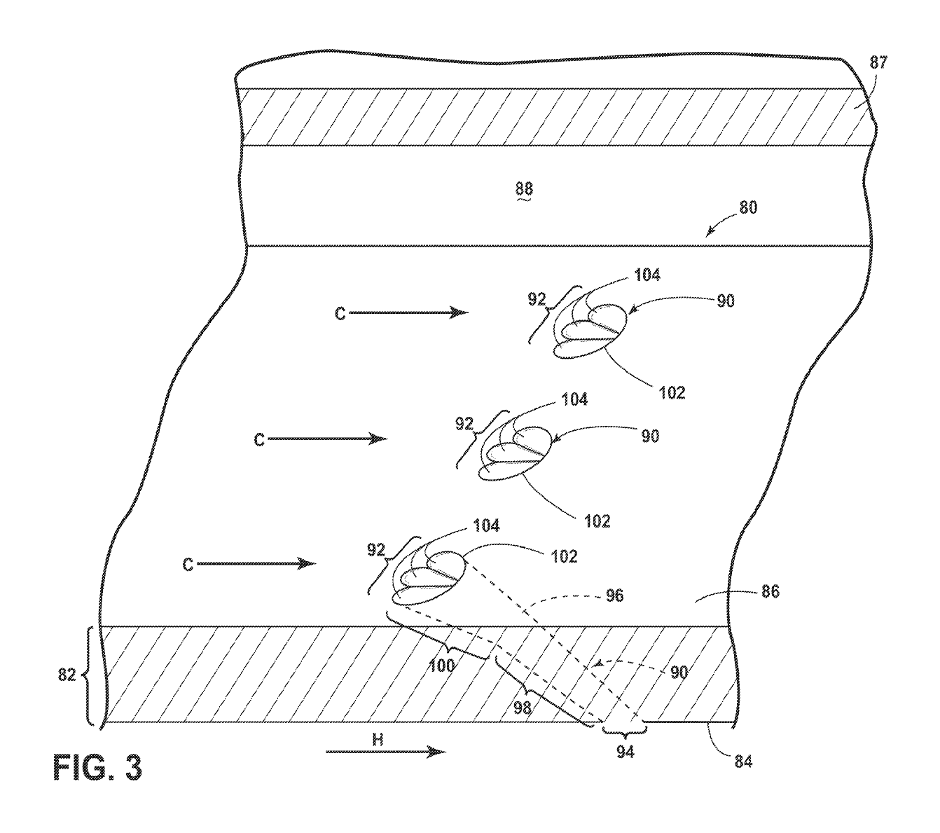

FIG. 3 is a schematic view showing a portion of an engine component 80 of the engine 10 from FIG. 1 according to a first embodiment of the invention. The engine component 80 can be disposed in a flow of hot gases represented by arrows H. A cooling fluid flow, represented by arrows C may be supplied to cool the engine component. As discussed above with respect to FIGS. 1-2, in the context of a turbine engine, the cooling air can be ambient air supplied by the fan 20 which bypasses the engine core 44, fluid discharged from the LP compressor 24, or fluid discharged from the HP compressor 26.

The engine component 80 includes at least one wall 82 having a hot surface 84 facing the hot combustion gas and a cooling surface 86 facing cooling fluid. In the case of a gas turbine engine, the hot surface 84 may be exposed to gases having temperatures in the range of 1000° C. to 2000° C. Suitable materials for the wall 82 include, but are not limited to, steel, refractory metals such as titanium, or super alloys based on nickel, cobalt, or iron, and ceramic matrix composites.

In the illustrated embodiment, a second wall 87 of the engine component 80 is shown, which, together with the first wall 82, defines at least one interior cavity 88, which comprises the cooling surface 86. The hot surface 84 may be an exterior surface of the engine component 80.

The engine component 80 further includes multiple film holes 90 that provide fluid communication between the interior cavity 88 and the hot surface 84 of the engine component 80. During operation, cooling air C is supplied to the interior cavity 88 and out of the film holes 90 to create a thin layer or film of cool air on the hot surface 84, protecting it from the hot combustion gas H.

Each film hole 90 can have an inlet 92 provided on the cooling surface 86 of the wall 82, an outlet 94 provided on the hot surface 84, and a passage 96 connecting the inlet 92 and outlet 94. Cooling fluid C enters the film hole 90 through the inlet 92 and passes through the passage 96 before exiting the film hole 90 at the outlet 94 along the hot surface 84.

The passage 96 can further define a metering section 98 for metering of the mass flow rate of the cooling fluid C. The metering section 98 can be a portion of the passage 96 with the smallest cross-sectional area, and may be a discrete location or an elongated section of the passage 96.

The present invention provides for a shaping or contouring of the film hole 90 by providing the inlet 92 with a flared portion 100 that flares inwardly from the cooling surface 86 about the entire circumference of the inlet 92. As used herein, the term “flared” and variations thereof, is defined as gradually becoming wider at one end. Here, the flared portion 100 is wider at the cooling surface 86 and narrows gradually in the downstream direction of the passage 96. The metering section 98 can be provided at or near the downstream end of the flared portion 100. In operation, cooling fluid C enters the film hole 90 through the inlet 92 and passes sequentially through the flared portion 100 and the metering section 98 before exiting the film hole 90 at the outlet 94 along the hot surface 84.

The flared portion 100 can be continuous about the circumference of the inlet 92 and can converge with the cooling surface 86 to create a radiused edge 102 at the cooling surface 86. The radiused edge 102 can define a maximum cross-sectional area of the flared portion 100, and can comprise a series of curved and/or linear segments defining the shape of the inlet 92 in the cooling surface 86.

The flared portion 100 can comprise one or more discrete lobes or flutes 104 around the otherwise circular or oblong cross section of the inlet 92. The flutes 104 may vary in shape and size along their length, but are generally largest near the inlet 92 and taper down to disappear at some point interior to the inlet 92 within the passage 96. The flutes 104 may be shaped in various ways, including being arcuate, multiply curved, straight, or piecewise linear.

The shaped inlets 92 can be configured to mitigate the effect that particles within the cooling fluid flow C have on cooling of the engine component 80, either through improved particle collection or improved particle flow. For example, the inlets 92 can be shaped to allow for expanded local flow areas in which particles may collect without affecting the metering section 98 of the film hole 90. In another example, when placed in particular locations around the periphery of the inlet 92, the flutes 104 provide a more gradual transition of the coolant flow turning into the film hole 90. This will allow the particles to be better retained in the fluid, rather than depositing on the engine component 80.

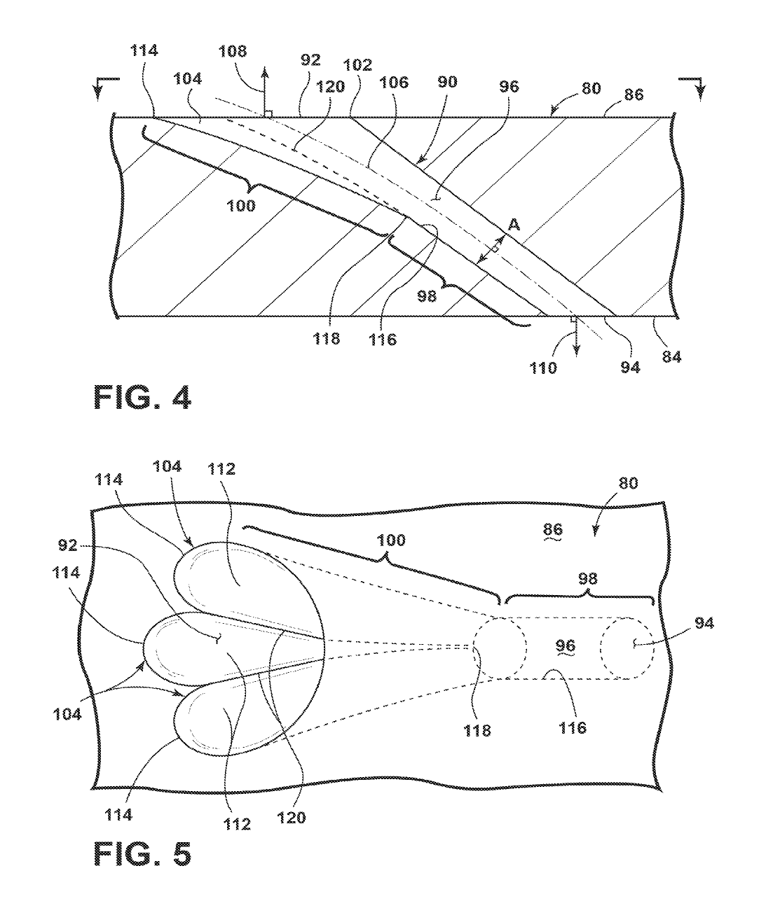

FIG. 4 is a sectional view through one of the film holes 90 of the engine component 80. The film hole 90 extends along a centerline 106 defined by the passage 96. The film hole 90 can be inclined in a downstream direction such that the centerline 106 is non-orthogonal to a local normal 108, 110 for either or both of the cooling surface 86 and the hot surface 84. The centerline 106 of the passage 96 is a line through the geometric centers of two-dimensional regions of the passage 96 perpendicular to the general direction of the cooling fluid flow C. The local normal 108 for the cooling surface 86 is a line extending perpendicularly from the cooling surface 86 at the intersection of the centerline 106 with the cooling surface 86. The local normal 110 for the hot surface 84 is a line extending perpendicularly from the hot surface 84 at the intersection of the centerline 106 with the hot surface 84.

It is noted that a streamline of the cooling fluid flow C may be generally collinear with the centerline 106 of the film hole 90 in areas where the passage 96 is circular or otherwise symmetrical. In areas where the passage 96 is irregular or asymmetrical, the streamline may diverge from the centerline 106.

The flared portion 100 converges toward the centerline 106 in the downstream direction. The cross-sectional area A of the metering section 98, defined with respect to a plane perpendicular to the centerline 106, may remain substantially constant between the flared portion 100 and the outlet 94. In other embodiments, the metering section 98 can have a cross-sectional area A that decreases toward the outlet 94, with the cross section being defined by a plane perpendicular to the centerline 106. In the illustrated embodiment, the metering section 98 further has the same cross-sectional shape as the outlet 94, which is circular in a plane perpendicular to the centerline 106. As the film hole 90 is inclined however, the outlet 94 can have an oval or elliptical plan form when viewed from the hot surface 84. Further, the inlet 92 and the flared portion 100 are greater in cross-sectional area than the metering section 98 and outlet 94.

FIG. 5 is a plan view of the cooling surface 86 of the engine component 80. In the illustrated example, multiple flutes 104 are provided on the upstream side of the inlet 92, relative to the direction of cooling fluid flow C, and are contiguous with each other. Each flute 104 can extend along a partial length of the film hole 90, such that the flutes 104 run generally parallel to a streamline of the cooling fluid flow C passing through the film hole 90.

The flutes 104 comprise concave recesses 112 with a convexly bowed ends 114 defined at the cooling surface 86. The concave recesses 112 can extend in a downstream direction to converge with or disappears into an inner surface 116 of the passage 96 at a distal end 118. Adjacent flutes 104 are contiguous with each other and are separated by ridges 120, which also converge with or disappear into the passage 96 at the downstream end. The recesses 112 can have a generally circular, ovoid, elliptical in shape, or a combination thereof, when viewed in cross-section. The bowed ends 114 can be generally circular, ovoid, or elliptical in shape, or combination thereof. The ridges 120 shown are created by the meeting of adjacent concave recesses 112, and may be a sharp edge or a smoothly radiused structure such as a convex edge.

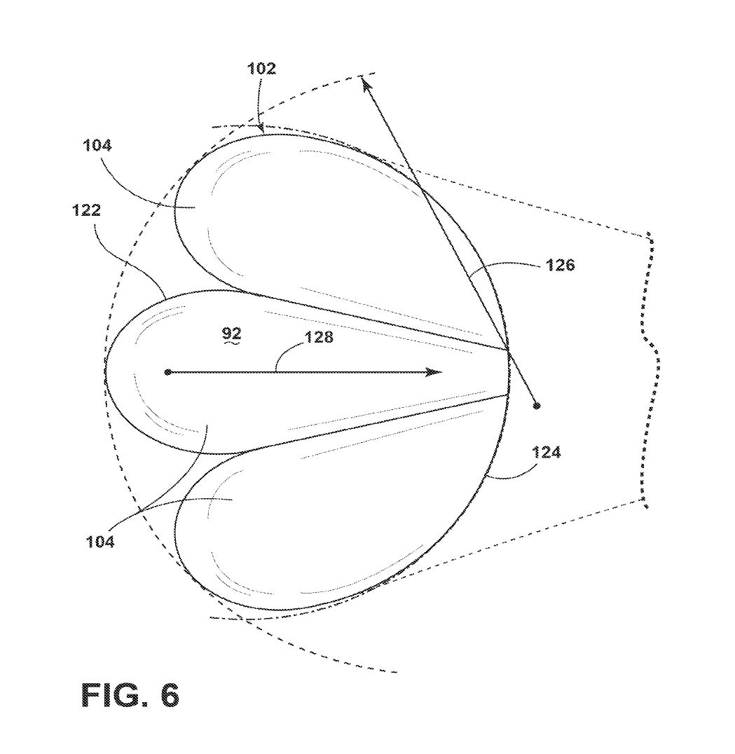

FIG. 6 is a plan view of the inlet 92. The radiused edge 102 shown is non-constant about the circumference of the inlet 92 due to the presence of the flutes 104, and generally includes a fluted edge segment 122 on the upstream side of the inlet 92 and a smooth edge segment 124 on the downstream side of the inlet 92. The segments 122, 124 each generally define a radius of curvature, with the radius of curvature 126 for the fluted edge segment 122 being measured for the smallest circular arc fitting all of the flutes 104 and the radius of curvature 128 for the smooth edge segment 124 being measured for a circular arc running along the segment 124 itself. In the illustrated embodiment, the radius of curvature 128 for the smooth edge segment 124 is less than the radius of curvature 126 of the fluted edge segment 122. In general terms, the inlet 92 is more tightly curved along its downstream side than its upstream side.

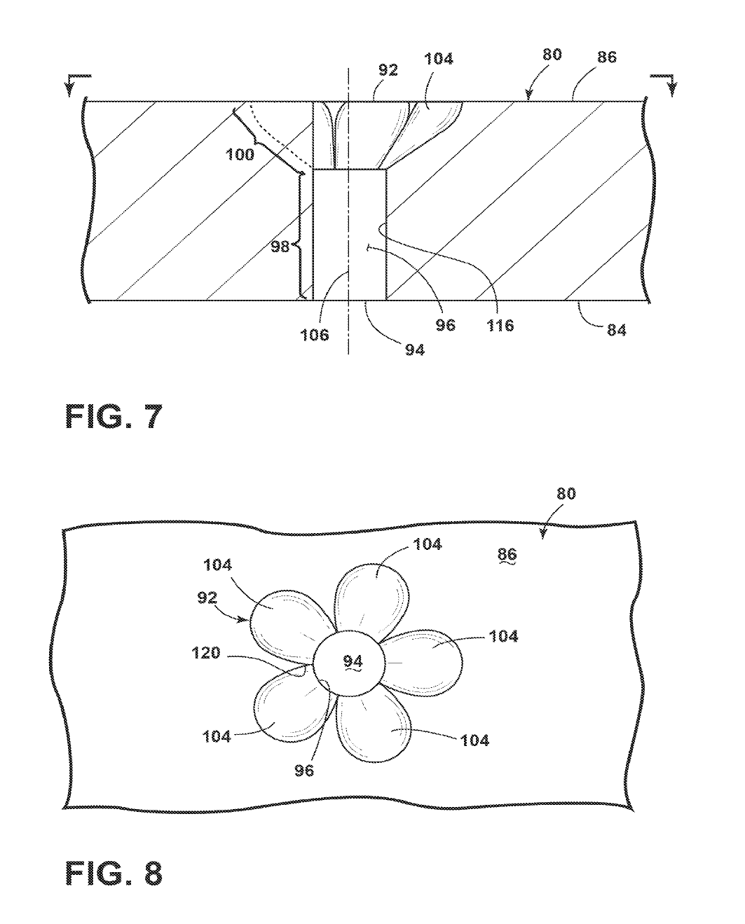

FIGS. 7-12 show alternative geometries for the film holes 90 of the engine component 80. The film holes 90 are substantially similar to the film holes 90 described for the first embodiment, and like elements are referred to with the same reference numerals.

FIGS. 7-8 are sectional and plan views of an engine component 80 having a film hole 90 in accordance with a second embodiment of the invention. The film hole 90 of the second embodiment differs from the first embodiment in that the film hole 90 is not inclined, such that the centerline 106 is orthogonal to both of the cooling surface 86 and the hot surface 84. Furthermore, the outlet 94 has a circular plan form when viewed from the hot surface 84. Still further, the flared portion 100 includes multiple contiguous flutes 104 spaced evenly about the circumference of the inlet 92, such that flutes are provided on both the upstream and downstream sides of the inlet 92.

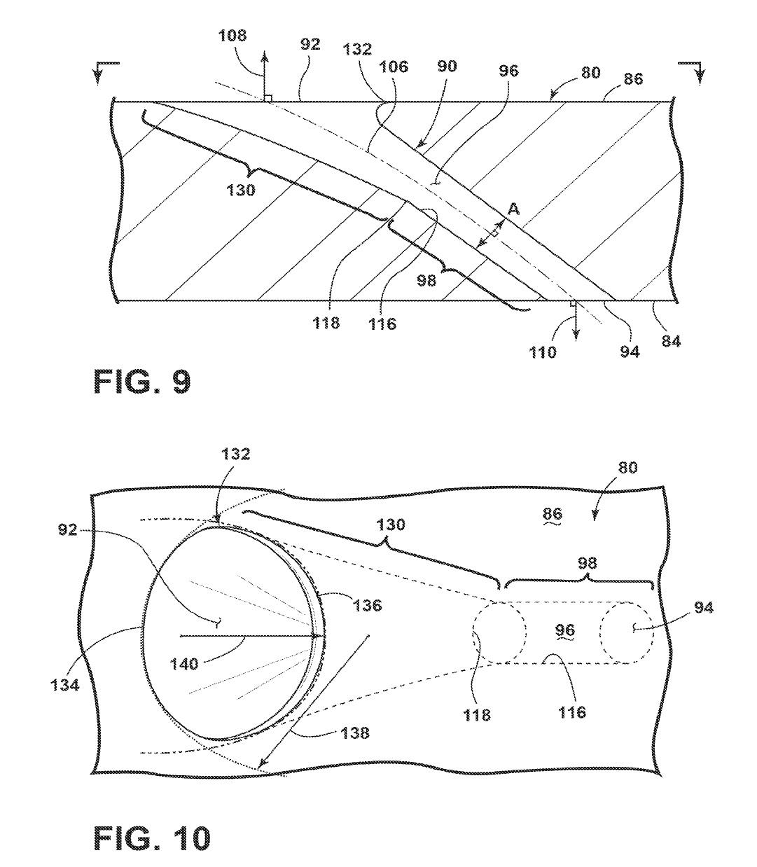

FIGS. 9-10 are sectional and plan views of an engine component 80 having a film hole 90 in accordance with a third embodiment of the invention. The film hole 90 of the third embodiment differs from the first embodiment in that the film hole 90 includes a non-fluted flared portion 130 that flares inwardly from the cooling surface 86 about the entire circumference of the inlet 92. Here, the flared portion 130 is wider at the cooling surface 86 and tapers smoothly in the downstream direction of the passage 96. The metering section 98 can be provided at or near the downstream end of the flared portion 100. In operation, cooling fluid C enters the film hole 90 through the inlet 92 and passes sequentially through the flared portion 130 and the metering section 98 before exiting the film hole 90 at the outlet 94 along the hot surface 84.

The flared portion 130 is continuous about the circumference of the inlet 92 and can converge with the cooling surface 86 to create a radiused edge 132 at the cooling surface 86. The radiused edge 132 shown is non-constant about the circumference of the inlet 92, and generally includes an upstream edge segment 134 on the upstream side of the inlet 92 and a downstream edge segment 136 on the downstream side of the inlet 92. The segments 134. 136 each generally define a radius of curvature 138, 140, respectively, with the radius of curvature 138, 140 for the edge segments 134, 136 being measured for a circular arc running along the segment 134, 136. In the illustrated embodiment, the radius of curvature 140 for the downstream edge segment 136 is less than the radius of curvature 138 of the upstream edge segment 134. In general terms, the inlet 92 is more tightly curved along its downstream side than its upstream side.

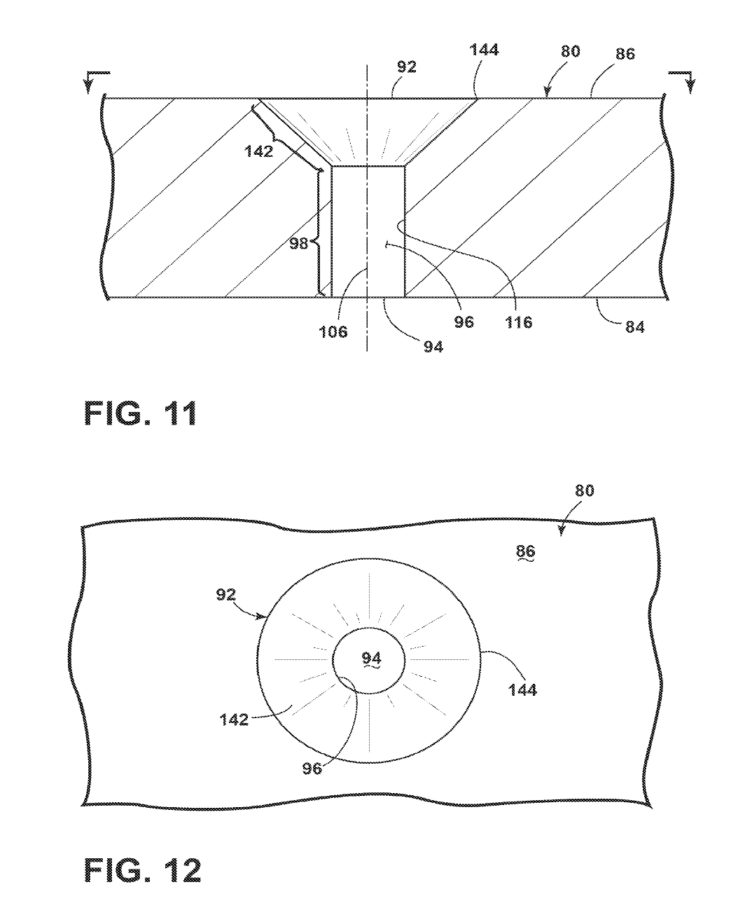

FIGS. 11-12 are sectional and plan views of an engine component 80 having a film hole 90 in accordance with a fourth embodiment of the invention. The film hole 90 of the fourth embodiment differs from the third embodiment in that the film hole 90 is not inclined, such that the centerline 106 is orthogonal to both of the cooling surface 86 and the hot surface 84. Furthermore, the outlet 94 has a circular plan form when viewed from the hot surface 84. Still further, the film hole 90 includes a flared portion 142 having a radiused edge 144 that is generally constant about the circumference of the inlet 92, such that the radiused edge 144 generally defines a circle in the cooling surface 86 and the flared portion 142 tapers smoothly from the radiused edge 144 toward the outlet 94.

Furthermore, in any of the above embodiments, a protective coating, such as a thermal barrier coating or multi-layer coating system, can be applied to the hot surface 84 of the engine component 80. Also, the present invention may be combined with shaping or contouring of the passage or outlet of the film holes. For example, the passage 96 can further define a diffusing section in which the cooling fluid C may expand to form a wider cooling film. The diffusion section can be downstream of the metering section 98 and defined at or near the outlet 94. The present invention may also apply to slot-type film cooling, in which case the outlets 94 are provided within a slot on the hot surface 84.

The various embodiments of systems, methods, and other devices related to the invention disclosed herein provide improved cooling for engine structures, particularly in a turbine component having film holes. One advantage that may be realized in the practice of some embodiments of the described systems is that the film hole can be shaped to include a flared or fluted inlet. Conventional film hole design utilizes a passage with a circular inlet region, a metering section, and a shaped outlet region to help diffuse the cooling fluid. By shaping the film hole to include a fluted inlet, improved cooling performance and mitigation of particle buildup in the engine component is achievable, which can lead to longer service life of the engine component.

Another advantage that may be realized in the practice of some embodiments of the described systems and methods is that the flutes allow for expanded local flow areas in which particulates may collect without affecting the metering section of the film hole. When placed in particular locations around the inlet periphery, such as upstream, downstream, or between these, the flutes provide a more gradual transition of the coolant flow turning into the film hole. This will allow particles to be better retained in the fluid flow, rather than depositing on the surfaces of the engine component.

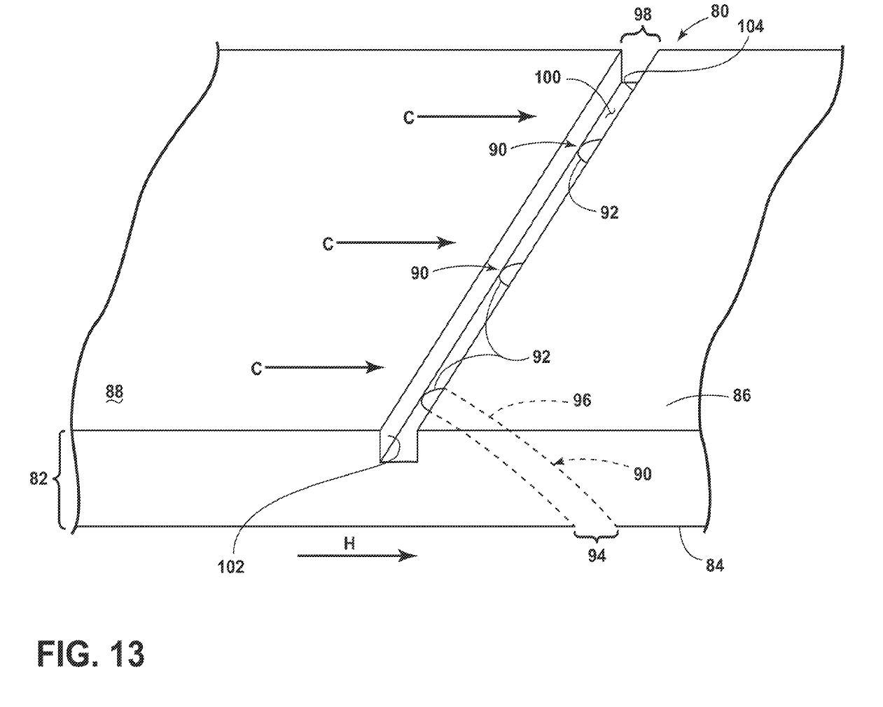

FIG. 13 is a schematic view showing an engine component 80 of the engine 10 from FIG. 1 according to fifth embodiment of the invention. The engine component 80 can be disposed in a flow of hot gases represented by arrows H. A cooling fluid flow, represented by arrows C may be supplied to cool the engine component. As discussed above with respect to FIGS. 1-2, in the context of a turbine engine, the cooling air can be ambient air supplied by the fan 20 which bypasses the engine core 44, fluid discharged from the LP compressor 24, or fluid discharged from the HP compressor 26.

The engine component 80 includes a wall 82 having a hot surface 84 facing the hot combustion gas and a cooling surface 86 facing cooling fluid. In the case of a gas turbine engine, the hot surface 84 may be exposed to gases having temperatures in the range of 1000° C. to 2000° C. Suitable materials for the wall 82 include, but are not limited to, steel, refractory metals such as titanium, or super alloys based on nickel, cobalt, or iron, and ceramic matrix composites.

The engine component 80 can define at least one interior cavity 88 comprising the cooling surface 86. The hot surface 84 may be an exterior surface of the engine component 80.

The engine component 80 further includes multiple film holes 90 that provide fluid communication between the interior cavity 88 and the hot surface 84 of the engine component 80. During operation, cooling air C is supplied to the interior cavity 88 and out of the film holes 90 to create a thin layer or film of cool air on the hot surface 84, protecting it from the hot combustion gas H.

Each film hole 90 can have an inlet 92 provided on the cooling surface 86 of the wall 82, an outlet 94 provided on the hot surface 84, and a passage 96 connecting the inlet 92 and outlet 94. Cooling fluid C enters the film hole 90 through the inlet 92 and passes through the passage 96 before exiting the film hole 90 at the outlet 94 along the hot surface 84.

The passage 96 can define a metering section for metering of the mass flow rate of the cooling fluid C. The metering section can be a portion of the passage 96 with the smallest cross-sectional area, and may be a discrete location or an elongated section of the passage 96. The passage 96 can further define a diffusing section in which the cooling fluid C may expand to form a wider cooling film. The diffusion section has a larger cross-sectional area of than the metering section. The metering section can be provided at or near the inlet 92, while the diffusion section can be defined at or near the outlet 94.

The present invention provides for a shaping or contouring of the cooling surface 86 of the engine component 80 by providing the cooling surface 86 with a contoured portion 98 that encompasses the inlets 92 of two or more film holes 90. Rather than shaping the entry region to each individual film hole 90, which may introduce undesirable stress increases locally, two or more film holes 90 adjacent one another have their entry regions, or inlets 92, encompassed within a broader surface contoured portion 98 to transition the flow more smoothly into the group of film holes 90. Likewise, such contouring may also serve other desirable local purposes, such as the provision of flow deflection as the fluid approaches the inlets 92 to divert particles from entering the film holes 90, or to prevent impact of particles on inlet surfaces, or to provide a more beneficial flow entry angle to the film holes 90.

The contoured portion 98 can encompass the inlets 92 of a partial row of film holes 90, or an entire row of film holes 90, whether that row be considered in a radial or axial direction, or otherwise oriented on the engine component 80. As shown in FIG. 13, the contoured portion 98 encompasses a row of film holes 90. While only a portion of the engine component 80 is shown, it is understood that the engine component 80 can have multiple rows of film holes 90, with each row having a corresponding contoured portion 98.

The contoured portion 98 of FIG. 13 comprises a concavity that extends across the cooling surface 86 and forms a trench or channel having a bottom wall 100 and two opposing side walls 102, 104. The two opposing side walls 102, 104 are parallel to each other, and the bottom wall 100 is substantially parallel to the cooling surface 86. The inlets 92 to the film holes 90 are formed in the bottom wall 100. In this embodiment, the channel has a square profile, in which the length of the bottom wall 100 is approximately the same as the length of the side walls 102, 104.

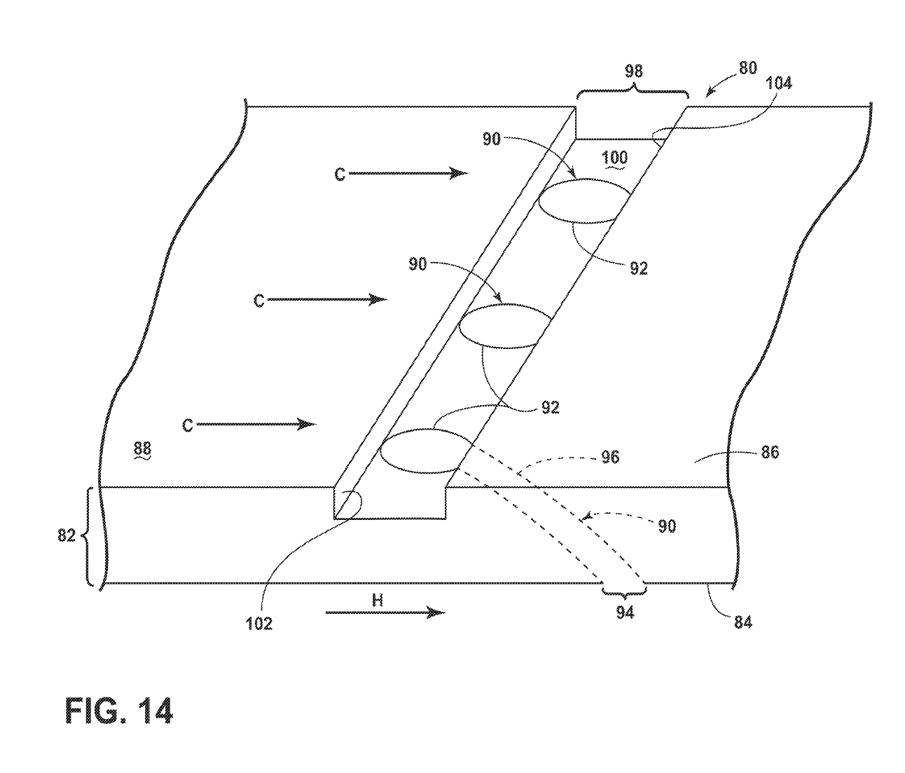

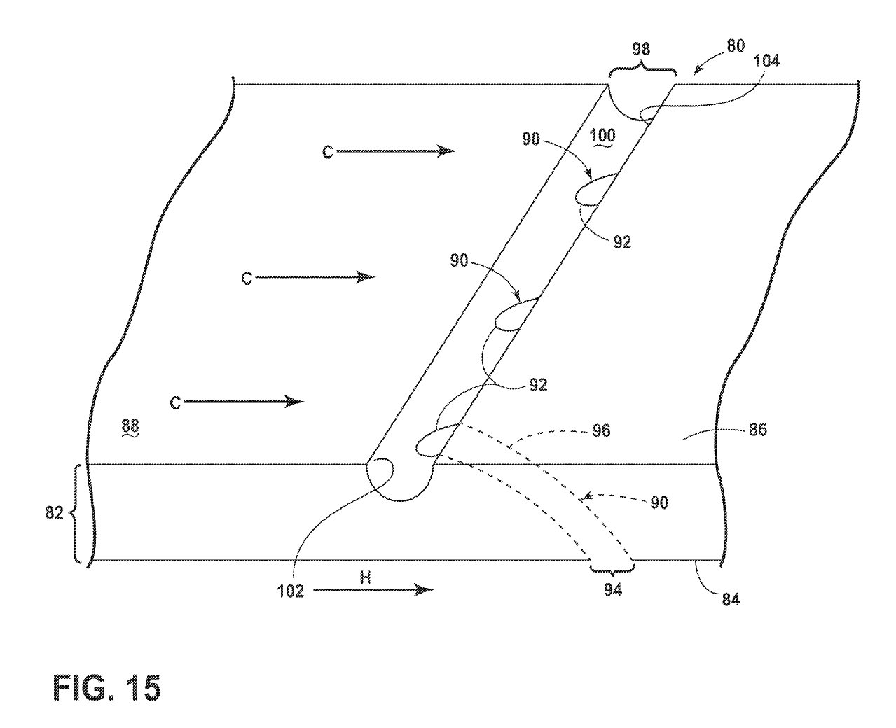

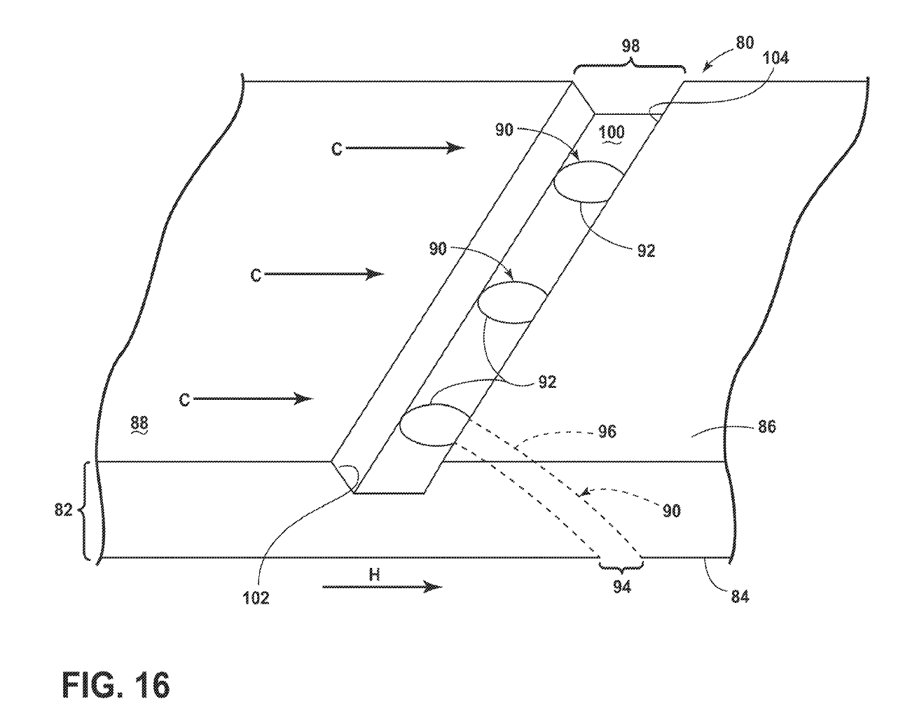

FIGS. 14-16 show some other profiles for the channel formed by the contoured portion 98. In FIG. 14, the channel has a rectangular profile, in which the bottom wall 100 is longer than the side walls 102, 104. In FIG. 15, the channel has a rounded profile, in which at least one side wall 102, 104 is rounded to have a curvilinear or arcuate shape. In FIG. 16, the channel has a beveled profile, in which at least one side wall 102, 104 is set at an angle relative to the bottom wall 100.

A single engine component 80 can be provided with one or more of the profiles shown in FIG. 13-16. Furthermore, while both the upstream and downstream side walls 102, 104 are shown as having the same profile, the walls 102, 104 can have different profiles. For example, the upstream side wall 102 can be rounded or beveled as shown in FIG. 15-16 and the downstream side wall 104 can be straight, as shown in FIG. 13. Other configurations of contoured depressions can be provided as well, including ones having a constant traverse shape or ones that have local contours around the inlets 92, but still include the inlets 92 within the same overall contoured portion.

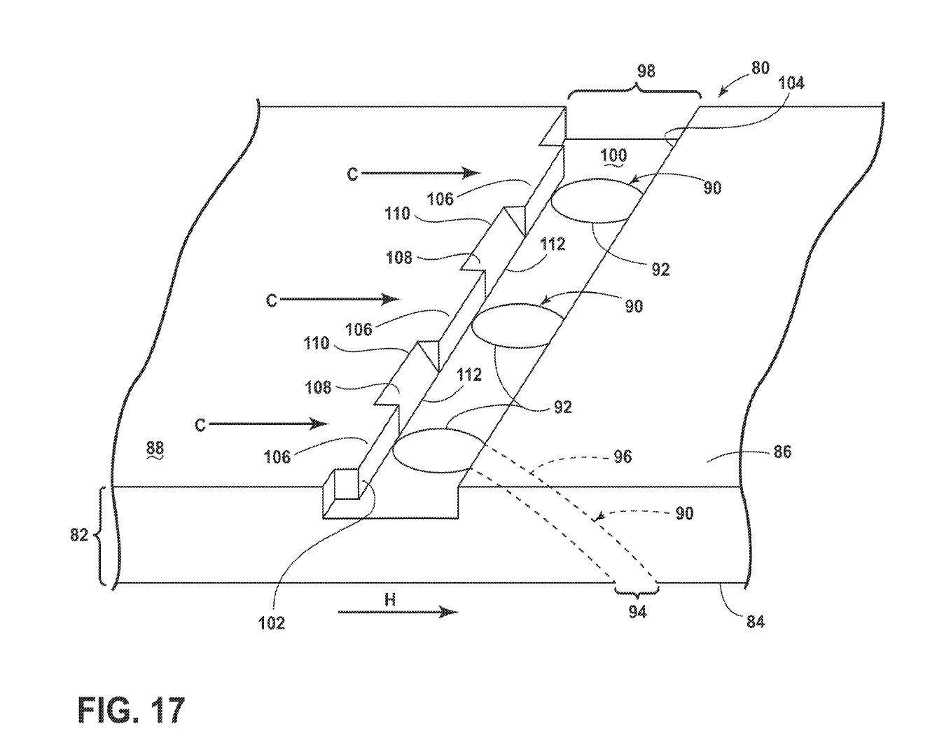

FIG. 17 shows another embodiment for the contoured portion 98 in which the contoured portion 98 includes a series of alternating ledges 106 and ramps 108 on the upstream side wall 102, such that the ledges 106 and ramps 108 are upstream of the inlets 92. The inlets 92 are aligned with the ledges 106, with the ramps 108 positioned between adjacent inlets 92. The ledges 106 are formed between adjacent ramps 108 by the convergence of the cooling surface 86 with the upstream side wall 102. The ramps 108 decline in the direction of the cooling fluid flow C, such that the upstream or top edge 110 of the ramp 108 is coincident with the cooling surface 86 and the downstream or bottom edge 112 of the ramp 108 is coincident with the bottom wall 100 of the channel. The ledges 106 and ramps 108 may have corners and edges as shown in FIG. 17, or alternatively may have rounded or blended profiles.

The ledges 106 upstream of the inlets 92 can define particle deflectors that prevent or at least reduce the number of particles that enter the film holes 90 by deflecting the particles away from the inlets 92. The height of the ledges 106 relative to the inlet 92 and/or the distance from the ledges 106 to the inlet 92 can be configured based on the expected size and speed of the particles in the cooling fluid flow C. Since the cooling fluid flow C is generally along a channel direction or has a main local direction and momentum as indicated by the arrows in FIG. 17, it will be difficult for particles to make the turn into the inlet 92. The ledges 106 define a severe turn into the inlets 92, and particles of about 5 microns in size or greater will not make this turn. Rather, the particles will be carried over the inlet 92. Further, as the velocity of the cooling fluid flow C is increased, smaller particle sizes will be denied into the inlets 92.

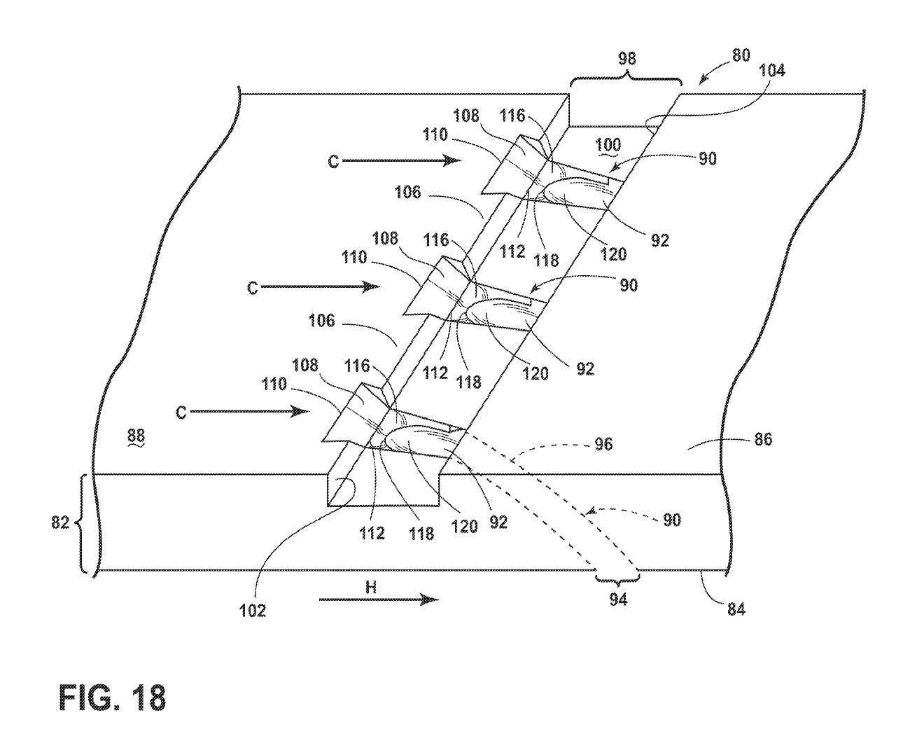

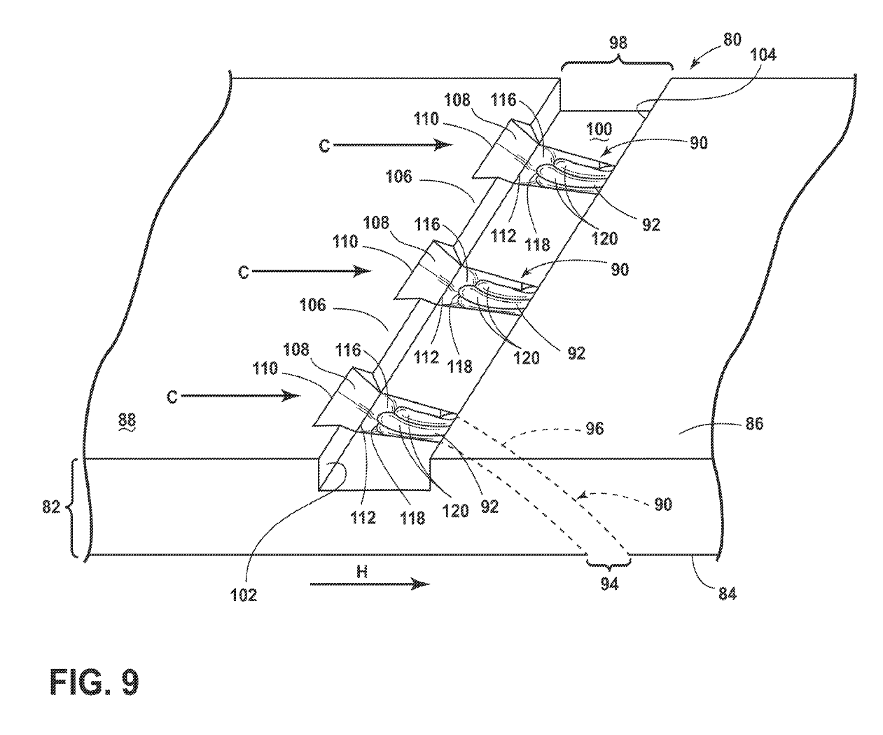

FIG. 18 shows another embodiment for the contoured portion 98 in which the contoured portion 98 also includes a series of alternating ledges 106 and ramps 108 on the upstream side wall 102, but in which the inlets 92 are aligned with the ramps 108, with the ledges 106 positioned between adjacent inlets 92. In this embodiment, the declined ramps 108 further taper inwardly in the downstream direction, such that the ramp 108 is wider at the top edge 110 and narrower at the bottom edge 112. The ledges 106 and ramps 108 may have corners and edges as shown in FIG. 18, or alternatively may have rounded or blended profiles.

The contoured portion 98 may further include smaller discrete features around the inlets 92, in addition to the broader feature of the channel. For example, FIG. 18 shows that the bottom wall 100 includes a flared portion 114 forming the inlets 92, with the downstream or bottom edge 112 of the ramp 108 being coincident with the flared portion 114. The flared portion 114 narrows toward the inlets 92, and includes a curved portion 116 in the bottom wall 100 that curves longitudinally with respect to the channel.

The curved portion 116 can meet the film hole 90 at a radiused edge 118. The radiused edge 118 can define at least one flute 120 forming the inlet 92. The at least one flute 120 may be arcuate, multiply curved so as to provide local recessed bowls, straight, or piecewise linear. As illustrated, the one flute 120 is arcuate and tapers into the passage 96. Thus, the ramp 108, curved portion 116 and flute 120 all taper in the direction the direction of the cooling fluid flow C to define a sequentially narrow path for cooling fluid into the film holes 90.

FIG. 19 shows another embodiment for the contoured portion 98 that is similar to FIG. 18, in which the contoured portion 98 includes multiple flutes 120 forming the inlets 92. The flutes 120 are oriented to taper toward the inlet 92, and are multiply curved so as to provide local recessed bowls at the inlet 92.

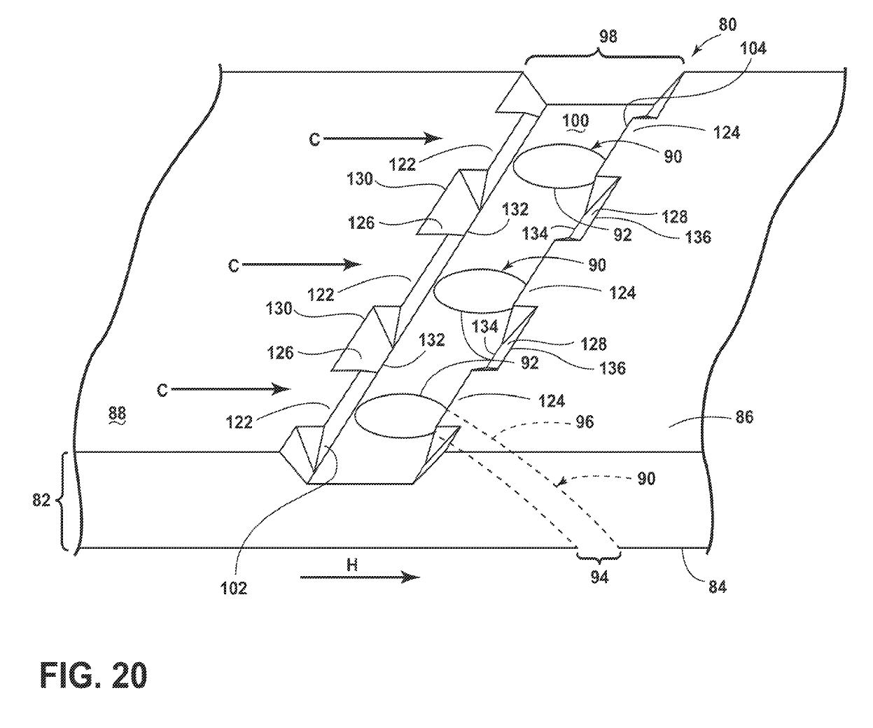

FIG. 20 shows another embodiment for the contoured portion 98 in which the contoured portion 98 includes a series of alternating ledges 122, 124 and ramps 126, 128 on both the upstream side wall 102 and the downstream side wall 104, such that ledges 122, 124 and ramps 126, 128 are provided both upstream and downstream of the inlets 92. The provision of ramps 126, 128 on both the upstream and downstream sides of the inlets 92 may be particularly suited to nozzles where the cooling fluid flow C is supplied by a low velocity cavity region.

The inlets 92 are aligned with the ledges 122, 124, with the ramps 126, 128 positioned between adjacent inlets 92. The ledges 122, 124 and ramps 126, 128 may have corners and edges as shown in FIG. 19, or alternatively may have rounded or blended profiles. In some instances, the ledges 122, 124 and ramps 126, 128 may be provided to deflect particles. Other reasons for providing the ledges 122, 124 and ramps 126, 128 at the inlets 92 include decreasing the sensitivity of film hole discharge coefficients to the specific local orientation and adjacent features or surfaces within the engine component 80, or decreasing the sensitivity to the momentum of the cooling fluid flow C approaching the inlet 92 and the resulting change of momentum the cooling fluid flow C must undergo to enter the inlet 92.

The ramps 126 on the upstream side wall 102 decline in the direction of the cooling fluid flow C, such that the upstream or top edge 130 of the ramp 126 is coincident with the cooling surface 86 and the downstream or bottom edge 132 of the ramp 126 is coincident with the bottom wall 100 of the channel. The declined ramps 126 further taper inwardly in the downstream direction, such that the ramp 126 is wider at the top edge 130 and narrower at the bottom edge 132.

The ramps 128 on the downstream side wall 104 incline in the direction of the cooling fluid flow C, such that the upstream or bottom edge 134 of the ramp 128 is coincident with the bottom wall 100 and the downstream or top edge 136 of the ramp 128 is coincident with the cooling surface 86. The inclined ramps 128 further taper outwardly in the downstream direction, such that the ramp 128 is narrower at the bottom edge 134 and wider at the top edge 136.

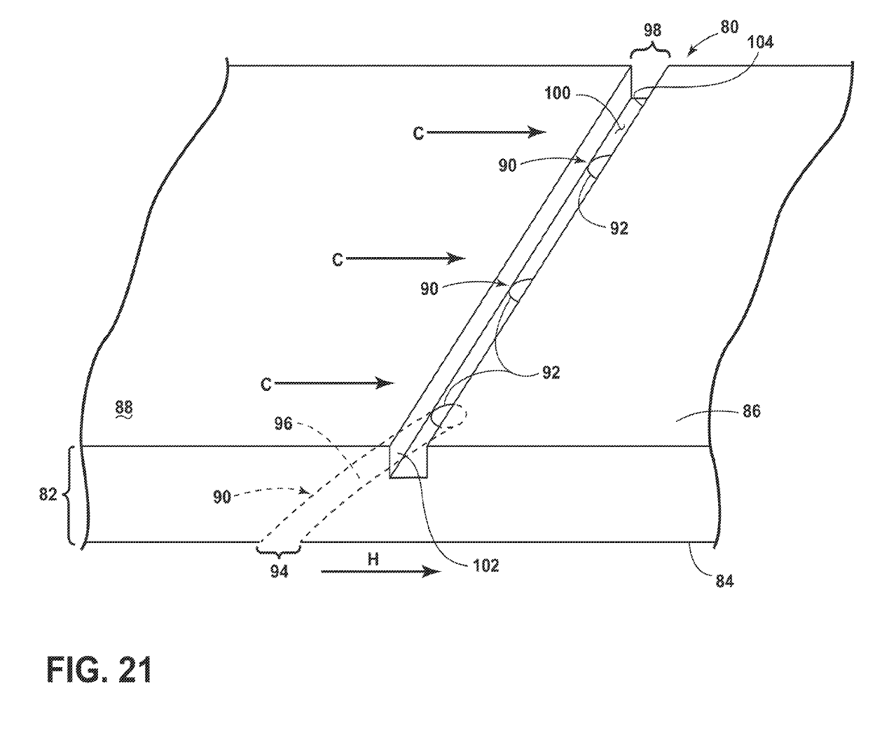

FIG. 21 is a perspective view of a portion of an engine component 80 according to a thirteenth embodiment of the invention. The thirteenth embodiment can be substantially similar to the fifth embodiment, and like elements are referred to with the same reference numerals. In the thirteenth embodiment, the film holes 90 have passages 96 within centerlines that have a component oriented opposite to the direction of the cooling fluid flow C. The cooling fluid enters the film hole 90 through the inlet 92 and reverses direction to pass through the passage 96 before exiting the film hole 90 at the outlet 94 along the hot surface 84. Such passages 96 may further be provided with any of the above embodiments of engine components 80.

In any of the above embodiments, it is understood that while the drawings may show the contoured portion having sharp corners, edges, and transitions for purposes of illustration, is may be more practical for the corners, edges, and/or transitions to be smoothly radiused or filleted to avoid the formation of stagnation points within the engine component 80.

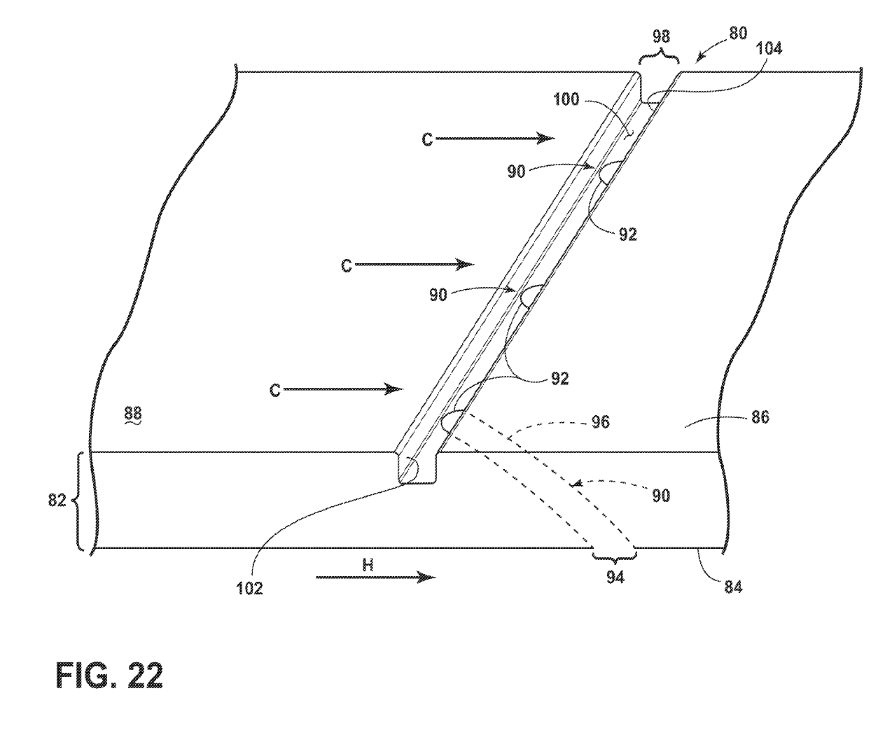

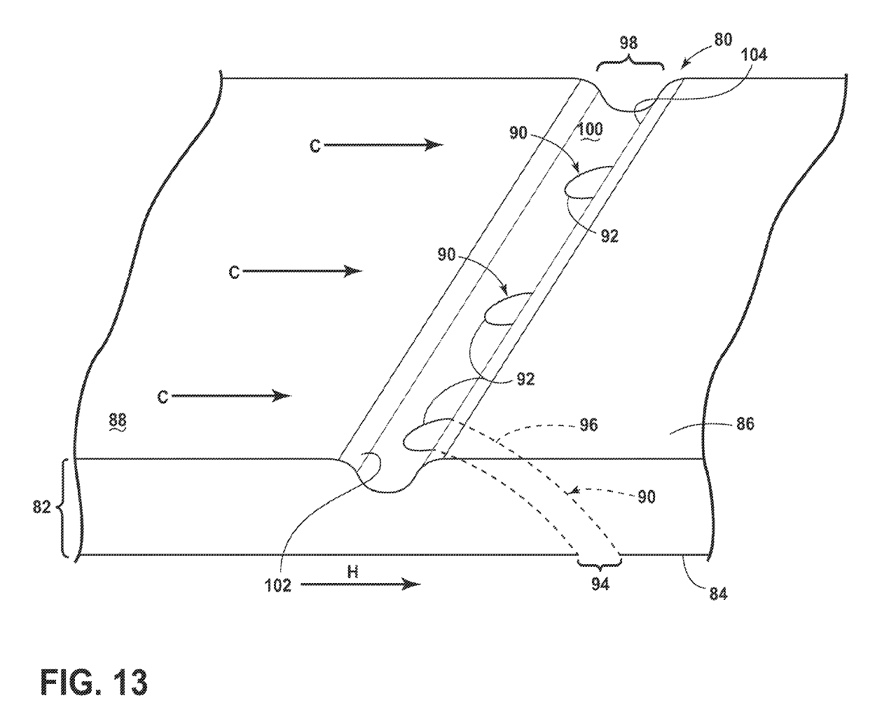

FIG. 22 is a perspective view of a portion of an engine component 80 according to a fourteenth embodiment of the invention. The fourteenth embodiment can be substantially similar to the fifth embodiment (FIG. 13), and like elements are referred to with the same reference numerals. In the fourteenth embodiment, the corners, edges, and/or transitions of the contoured portion 98 are shown as being smoothly radiused or filleted. Specifically, the curvilinear or arcuate side walls 102, 104 meet the cooling surface 86 at a radiused edges and meet the bottom wall 100 at radiused corners.

FIG. 23 is a perspective view of a portion of an engine component 80 according to an fifteenth embodiment of the invention. The fifteenth embodiment can be substantially similar to the seventh embodiment (FIG. 15), and like elements are referred to with the same reference numerals. In the fifteenth embodiment, the corners, edges, and/or transitions of the contoured portion 98 are shown as being smoothly radiused or filleted. Specifically, the curvilinear or arcuate side walls 102, 104 meet the cooling surface 86 at a radiused edges.

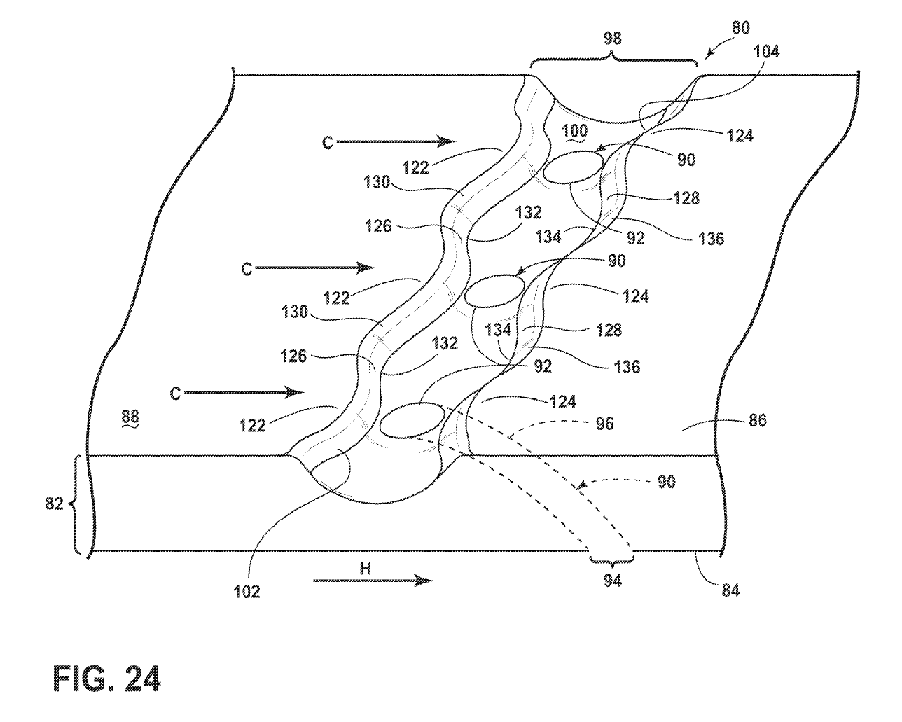

FIG. 24 is a perspective view of a portion of an engine component 80 according to a sixteenth embodiment of the invention. The sixteenth embodiment can be substantially similar to the twelfth embodiment (FIG. 20), and like elements are referred to with the same reference numerals. In the sixteenth embodiment, the corners, edges, and/or transitions of the contoured portion 98 are shown as being smoothly radiused or filleted, with the upstream side wall 102 and the downstream side wall 104 following a generally sinusoidal contour. Specifically, the ledges 122, 124 meet the cooling surface 86 at a radiused edges and meet the bottom wall 100 at radiused corners. Likewise, the ramps 126, 128 meet the cooling surface 86 at a radiused edges and meet the bottom wall 100 at radiused corners.

While many of the embodiments show the contoured portion 98 extending across the cooling surface 86 in a channel-like manner, this need not be the case. The cooling surface 86 can comprise discrete and multiple contoured portion 98 that do or do not extend entirely across the cooling surface 86 of the component 80. The embodiments also show the inlets 92 primarily located in the geometric center of the contoured portion 98, which is also not necessary for the invention. The inlets 92 can be located anywhere within the contoured portion 98. With respect to the cooling fluid flow C, the inlets 92 can be located at either an upstream or downstream edge of the contoured portion 98. The inlets 92 can even be partially located outside the contoured portion 98. The inlets 92 may be located on any area of the contoured portion 98, be it a flat area or curved area.

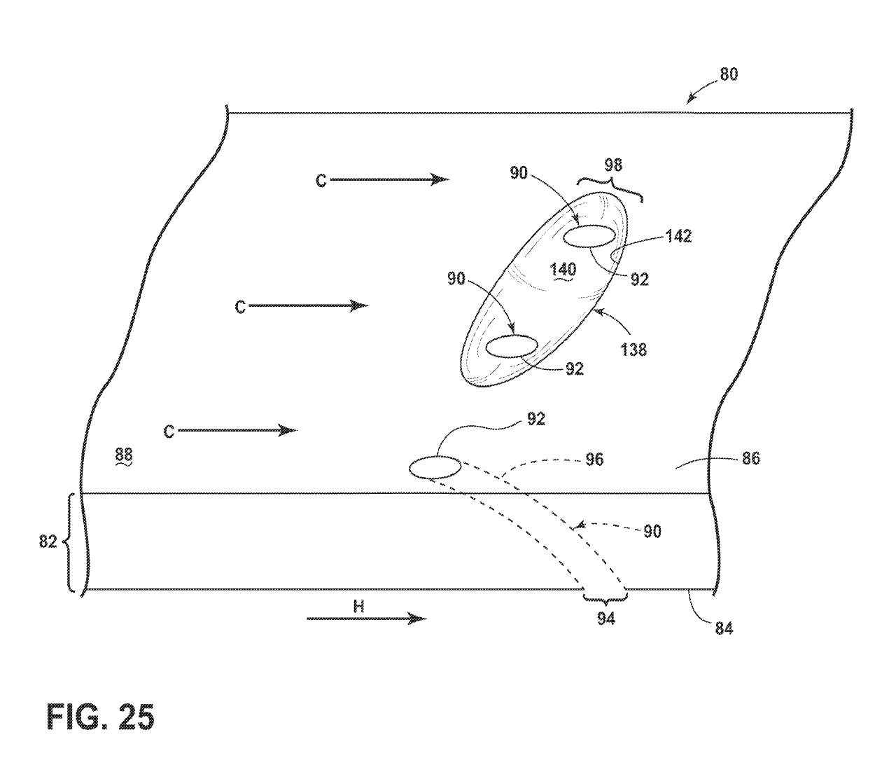

FIG. 25 is a perspective view of a portion of an engine component 80 according to a seventeenth embodiment of the invention. The seventeenth embodiment can be generally similar to the previous embodiments, and like elements are referred to with the same reference numerals. In the seventeenth embodiment, the contoured portion 98 comprises an ellipsoidal concavity 138 encompassing the inlets 92 of two film holes 90. The component 80 includes a third film hole 90 that is not encompassed by the ellipsoidal concavity 138.

The ellipsoidal concavity 138 extends only partially across the cooling surface 86 and includes an incurvate recessed surface 140 that meets the cooling surface 86 at a perimeter edge 142. The perimeter edge 142 can be smoothly radiused or filleted to avoid the formation of stagnation points within the engine component 80.

In the above embodiments, the cooling fluid flow C is shown as being in a direction generally across the cooling surface 86 of the engine component 80, with the film holes 90 being arranged in a row extending generally transverse to the direction of the cooling fluid flow C. However, other row orientations with respect to the main direction of the cooling fluid flow C are possible. For example, for some engine components, most notably blades, the film holes 90 may be arranged in a row having an orientation parallel to that of the cooling fluid flow C. Is it noted that the cooling fluid flow C is turbulent, and is composed of directional components or vectors, particularly on a local scale with respect to the film holes, but that the main or bulk flow direction can be transverse to, parallel to, or some combination thereof, the row of film holes.

In any of the above embodiments, a protective coating, such as a thermal barrier coating, or multi-layer protective coating system can be applied to the hot surface 84 of the engine component 80. It is also understood that the film holes 90 and inlets 92 may have various orientations, not just the axial orientations shown in the figures. Furthermore, the present invention may be combined with shaping or contouring of the outlet 94 and passage 96 of the film holes 90. The present invention may also apply to slot-type film cooling, in which case the outlets 94 are provided within a slot on the hot surface 84.

The various embodiments of systems, methods, and other devices related to the invention disclosed herein provide improved cooling for engine components, particularly in an engine component having film holes. One advantage that may be realized in the practice of some embodiments of the described systems is that the cooling surface of the engine component can be shaped to include a contoured portion encompassing the inlets of multiple film holes. Conventional film hole design utilizes a passage with a circular inlet region, a metering section, and a shaped outlet region to help diffuse the cooling fluid. However, shaping of the inlet region has been limited. By shaping the film hole to include a contoured inlet region, improved cooling performance and mitigation of particle buildup in the engine component is achievable, which can lead to longer service life of the engine component.

Another advantage that may be realized in the practice of some embodiments of the described systems and methods is that multiple film holes may be encompassed within a regional contoured portion. Conventionally, surface contouring of film hole inlets requires local shaping around or into each individual film hole. By encompassing multiple inlets within a common contour, local design needs may be met, including protection against particles impacting the inlet surfaces, preconditioning the cooling fluid flow with additional pressure loss to obtain a better film exit condition, re-directing the cooling fluid flow to provide a more beneficial entry vector into the film holes, or eliminating the typical entry flow separation and consequent high turbulence and/or shock inside the film holes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An engine component for a gas turbine engine, the gas turbine engine generating hot combustion gas, comprising:
a wall at least partially defining an interior cavity and separating the hot combustion gas from a cooling fluid flow supplied to the interior cavity and having a hot surface facing the hot combustion gas and a cooling surface facing the cooling fluid flow; and
a film hole having an inlet provided on the cooling surface, an outlet provided on the hot surface, and a passage connecting the inlet and the outlet, with the passage defining a metering section;
wherein the inlet comprises a flared portion flaring inwardly from the cooling surface and about the entire circumference of the inlet.

2. The engine component of claim 1 wherein the flared portion comprises at least one flute.

3. The engine component of claim 2 wherein the at least one flute tapers inwardly from the inlet toward the passage.

4. The engine component of claim 2 wherein the at least one flute comprises multiple flutes.

5. The engine component of claim 4 wherein the multiple flutes are circumferentially spaced about the inlet.

6. The engine component of claim 5 wherein the multiple flutes are contiguous.

7. The engine component of claim 1 wherein the flared portion is continuous about the circumference of the inlet.

8. The engine component of claim 1 wherein the flared portion comprises a radiused edge at the cooling surface.

9. The engine component of claim 8 wherein the radiused edge is non-constant about the circumference of the inlet.

10. The engine component of claim 9 wherein the radius of curvature of the radiused edge along a downstream side, relative to the cooling fluid flow direction, is less than the radius of curvature of the radiused edge along an upstream side.

11. The engine component of claim 1 wherein the passage defines a centerline that is orthogonal to a local normal for both of the cooling surface and the hot surface.

12. The engine component of claim 1 wherein the passage defines a centerline that is non-orthogonal to a local normal for both of the cooling surface and the hot surface.

13. The engine component of claim 1 wherein the outlet and the metering section have the same cross-sectional area.

14. The engine component of claim 11 wherein the outlet and the metering section have the same cross-sectional shape.

15. The engine component of claim 13 wherein the cross-sectional shape is a circle.

16. The engine component of claim 15 wherein the flared portion comprises at least one portion with a cross-sectional area greater than the cross-sectional area of the outlet and the metering section.

17. The engine component of claim 1 wherein the engine component comprises at least one of a nozzle, a vane, a blade, a shroud, a combustor liner, or a combustor deflector.

18. The engine component of claim 1 wherein the wall is an exterior wall of the engine component, which defines an interior to which cooling fluid flow is supplied.

19. An engine component for a gas turbine engine, the gas turbine engine generating hot combustion gas, comprising:
a wall at least partially defining an interior cavity and separating the hot combustion gas from a cooling fluid flow supplied to the interior cavity and having a hot surface facing the hot combustion gas and a cooling surface facing the cooling fluid flow; and
a film hole having an inlet provided on the cooling surface, an outlet provided on the hot surface, and a passage connecting the inlet and the outlet, with the passage defining a metering section;
wherein the inlet comprises at least one flute extending inwardly from the cooling surface to the passage.

20. The engine component of claim 19 wherein the at least one flute narrows in width in a direction from the inlet toward the passage.

21. The engine component of claim 20 wherein the at least one flute comprises multiple flutes circumferentially spaced about the inlet.

22. The engine component of claim 21 wherein the at least one flute tapers from the inlet toward the passage.

23. The engine component of claim 21 wherein the at least one flute comprises multiple flutes.

24. The engine component of claim 23 wherein the multiple flutes are contiguous.

25. The engine component of claim 19 wherein the at least one flute extends along a partial length of the passage in a direction generally parallel to a streamline of fluid passing through the film hole.

26. The engine component of claim 19 wherein the passage defines a centerline that is orthogonal to a local normal for both of the cooling surface and the hot surface.

27. The engine component of claim 19 wherein the passage defines a centerline that is non-orthogonal to a local normal for both of the cooling surface and the hot surface.

28. The engine component of claim 19 wherein the engine component comprises at least one of a nozzle, a vane, a blade, a shroud, a combustor liner, or a combustor deflector.

29. The engine component of claim 19 wherein the wall is an exterior wall of the engine component, which defines an interior to which cooling fluid flow is supplied.

30. An engine component for a gas turbine engine, the gas turbine engine generating hot combustion gas, comprising:
a wall separating the hot combustion gas from a cooling fluid flow and having a hot surface facing the hot combustion gas and a cooling surface facing the cooling fluid flow;
multiple film holes having an inlet provided on the cooling surface, an outlet provided on the hot surface, and a passage connecting the inlet and the outlet, with the passage defining a metering section; and
a contoured portion provided in the cooling surface and encompassing the inlets for at least two of the film holes.

31. The engine component of claim 30 wherein the contoured portion comprises a particle deflector upstream of the encompassed inlets, relative to the cooling fluid flow direction.

32. The engine component of claim 31 wherein at least one of the height of the particle deflector and the location of the particle deflector upstream to the encompassed inlets is predetermined based on the expected size and speed of the particles in the cooling fluid flow.

33. The engine component of claim 30 wherein the contoured portion comprises a channel formed in the cooling surface with the encompassed inlets located in the channel.

34. The engine component of claim 33 wherein the upstream side of the channel comprises a ledge.

35. The engine component of claim 34 wherein the downstream side of the channel comprises a ledge with at least one inclined ramp which is angled upwardly from a bottom of the channel.

36. The engine component of claim 35 wherein the encompassed inlets are spaced from each other and the at least one inclined ramp is downstream of and between the encompassed inlets.

37. The engine component of claim 36 wherein the upstream side of the channel further comprises at least one declined ramp which is angled downwardly toward the bottom of the channel.

38. The engine component of claim 37 wherein the at least one declined ramp lies between the encompassed inlets.

39. The engine component of claim 38 wherein the at least one inclined ramp tapers outwardly in the downstream direction and the at least one declined ramp tapers inwardly in the downstream direction.

40. The engine component of claim 39 wherein the passage defines a centerline which has a component in the upstream direction.

41. The engine component of claim 30 wherein the inlets of the multiple film holes are arranged in at least one row and the contoured portion encompasses all of the inlets in one of the rows.

42. The engine component of claim 41 further comprising multiple contoured portions, with each row of inlets having a corresponding contoured portion.

43. The engine component of claim 30 wherein the contoured portion comprises a series of alternating ledges and ramps.

44. The engine component of claim 43 wherein at least one of the encompassed inlets is aligned with one of the ledges or one of the ramps.

45. The engine component of claim 44 wherein at least some of the ramps are inclined ramps or declined ramps.

46. The engine compartment of claim 45 wherein the series of alternating ledges and ramps is upstream or downstream of the encompassed inlets.

47. The engine component of claim 30 wherein the passage defines a centerline which has a component in the upstream direction of the cooling fluid flow.

48. The engine component of claim 30 wherein the contoured portion comprises a flared portion in the cooling surface and forming the inlets.

49. The engine component of claim 48 wherein the flared portion comprises at least one flute.

50. The engine component of claim 49 wherein the at least one flute changes in width in a flow direction into the inlet.

51. The engine component of claim 49 wherein the at least one flute comprises multiple flutes.

52. The engine component of claim 48 wherein the contoured portion comprises a curved portion in the cooling surface.

53. The engine component of claim 30 wherein the contoured portion comprises a concavity in the cooling surface.

54. The engine component of claim 52 wherein the concavity comprises a channel having a bottom wall and two opposing side walls.

55. The engine component of claim 54 wherein the two opposing side walls are parallel to each other.

56. The engine component of claim 54 wherein at least one of the two opposing side walls is rounded.

57. The engine component of claim 54 wherein at least one of the two opposing side walls is beveled relative to the bottom wall.

58. The engine component of claim 54 wherein the encompassed inlets are formed in the bottom wall.
